(19) United States
(12) Patent Application Publication
(10) Pub. No.: US 2005/0179365 A1
(43) Pub. Date: Aug. 18, 2005

(54) Active matrix display device

(76) Inventors: Steve C Deane, Redhill (GB); Dirkjan B. van Dam, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/512,331

(22) PCT Filed: Apr. 10, 2003
(86) PCT No.: PCT/IB03/01461

(30) Foreign Application Priority Data
Apr. 26, 2002 (GB) 0209555.2
Jun. 18, 2002 (GB) 0213934.3

(51) Int. Cl. H05B 33/08; H05B 33/10

(52) U.S. Cl. 313/500; 313/505; 445/24

(57) ABSTRACT

A matrix display comprising an array of pixels (2), each pixel having a first electrode (14,16) of oscillating width overlapping with a second electrode (28,36). The area of overlap in each pixel between the second electrode and the first electrode is varied across the array in a substantially irregular manner to counteract display artefacts. The first electrode may be defined by a printing process for example.

The present invention relates to matrix display devices and the manufacture thereof. More particularly it relates to the use of printing or direct-write techniques in the fabrication of such devices.

Known processes for making arrays of electronic components in matrix display devices involve depositing material in sheet form over a substrate and then using photolithography and etching to pattern the material. The need to deposit material layers, define photoresist on each layer, and then etch away typically 95% of each material layer makes these techniques costly. The high performance patterning tools required have limited throughput and use large quantities of expensive photoresist and developer.

As an alternative, it has been proposed to print or write directly materials onto the substrate in the desired pattern, thus eliminating blanket deposition, and masked exposure processes. For example, photoresist masks may be printed onto one or more layers of material to be patterned using a jet-printing nozzle. Such a technique is described in “Amorphous silicon thin-film transistors and arrays fabricated by jet printing”, by W. S. Wong et al, Applied Physics Letters, Vol. 80, No. 4, 28th January 2002, the contents of which are hereby incorporated herein by reference. In other techniques, material forming the finished devices (or a precursor of that material) may be printed in the desired pattern. References herein to printing of electrode material include printing of a precursor material, which is converted into the material of the finished electrode by further processing.

The English language abstract of JP-A-11-274681 provided by the Japanese Patent Office describes the formation of electronic devices using printing. The gate electrode of a thin film transistor (hereinafter referred to as a “TFT”) is formed using ink jet printing.

It is an object of the present invention to provide improved matrix display devices using printing or direct-write techniques to form electronic components thereof, and to provide an improved method for manufacture of such display devices.

The present invention provides a matrix display device comprising an array of pixels, each pixel having a first electrode of oscillating width overlapping with a second electrode, wherein the area of overlap in each pixel between the second electrode and the first electrode is varied across the array in a substantially irregular manner to counteract display artefacts.

In a preferred embodiment, the first electrode is defined using a printing process. More particularly, the first electrode may be formed of a line of adjoining droplets. An example of a printing technique which may be used to form electrodes comprising adjoining droplets is ink jet printing. Alternatively, the first electrode may be formed by uniform deposition of first electrode material, followed by printing or direct-writing of a mask defining the desired configuration of the first electrode. The exposed first electrode material is then etched away and the mask stripped off to leave the first electrode in the required pattern.

In a transmissive display, the electrodes should be as narrow as possible to maximise the aperture of the pixels. The inventors have found that as the width of lines created using a printing process such as ink jet printing approaches the minimum possible for a given printing apparatus, the outline of the individual droplets of which the line is composed becomes visible. This results in a regular variation in the line width along its length. The inventors have realised that this is a cause of degradation of the performance of a display. As the pixels are mutually equally spaced, the areas of overlap between other electrodes of electronic components of the pixels (overlying or underlying lines defined by printing) and lines defined by printing will vary periodically across the display, in a beating effect. Accordingly, the capacitances formed by the other electrodes coupling with the lines defined by printing vary in the same way. The characteristics of the pixels therefore vary periodically across the display.

It will be appreciated that this oscillating line width may result whether the electrode material itself is directly-written or a mask is directly-written and used to pattern the electrode material. Periodic variation at an edge of the mask will be replicated in the underlying electrode material.

The transmissivity of a pixel is very sensitive to the voltage across it, so even a slight periodic variation is likely to have a significant effect. Furthermore, the human eye is very sensitive to any periodic variation in transmissivity across a display. Where a display is driven using an inversion drive scheme, such variation will manifest itself as flicker, which is readily apparent to the eye.

According to the invention, the area of overlap between a first electrode and a second electrode of an electronic component in each pixel is predetermined to vary in a substantially irregular manner in a given direction across the array to avoid a beating effect of the form described above. Thus any variation in the associated capacitance is substantially non-periodic or random across the display. It will be appreciated that the second electrode may lie over the first electrode or vice versa.

In a preferred embodiment, wherein lines are formed and adjoining droplets, the droplets are substantially equally spaced along each line, but the position of the second electrodes relative to the droplets in each pixel is varied in a substantially irregular manner along each line. Alternatively, the second electrodes in respective pixels are substantially equally spaced along each line of droplets and the positions of the droplets relative thereto in each pixel are varied in a substantially irregular manner along each line. Preferably, in the latter embodiment, the spacing of the droplets along each line between the components is adjusted substantially evenly along the respective line to achieve said variation. Thus movement of a droplet from the position it would occupy if the droplets were equally spaced along an electrode is accommodated gradually by the droplets on one or both sides thereof. This serves to avoid a particularly large or small spacing between the droplet and its neighbours, which may cause an exceptionally large change in the line width, affecting the overlap between the droplet and another electrode, or even result in a break in the printed line.

In some embodiments of the invention, an electronic component in each pixel includes the overlapping portions of the first and second electrodes. The electronic component may be a TFT in each pixel. More particularly, the second electrode may be the drain electrode of the TFT connected to a respective pixel electrode, and the first electrode may be the gate electrode of the TFT.

Alternatively, the electronic component may be a storage capacitor in each pixel, spaced along storage capacitor lines of the display which are defined by printing.

In another preferred embodiment, each pixel includes a further electronic component having a third electrode of oscillating width overlapping with a fourth electrode, wherein the area of overlap in each pixel between the third and fourth electrodes of the further component is varied across the array in a substantially irregular manner to counteract display artefacts. For example, one electronic component may be a TFT in each pixel and the further component may be a storage capacitor in each pixel.

The row electrodes of the display may be formed by the first electrodes, and additionally, a respective portion of the row electrode may form the gate electrode of a TFT in each pixel.

The present invention further provides a method of manufacturing a matrix display device comprising an array of pixels, each pixel having a first electrode of oscillating width overlapping with a second electrode, the method comprising the steps of printing the first electrode in each pixel, and defining the second electrode in each pixel, wherein the area of overlap in each pixel between the second electrode and the first electrode is varied across the array in a substantially irregular manner to counteract display artefacts. Preferably, the first electrode is formed in each pixel by ink jet printing a line of adjoining droplets.

Embodiments of the invention will now be described by way of example and with reference to the accompanying schematic drawings, wherein:

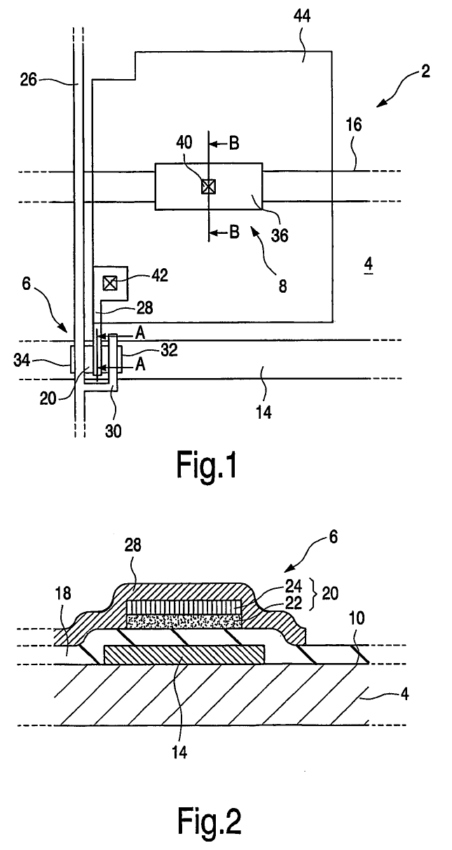

FIG. 1 shows a plan view of an active matrix display pixel including a TFT and a storage capacitor partly formed using printing techniques;

FIG. 2 shows a cross-sectional view of the TFT of FIG. 1 along line A-A;

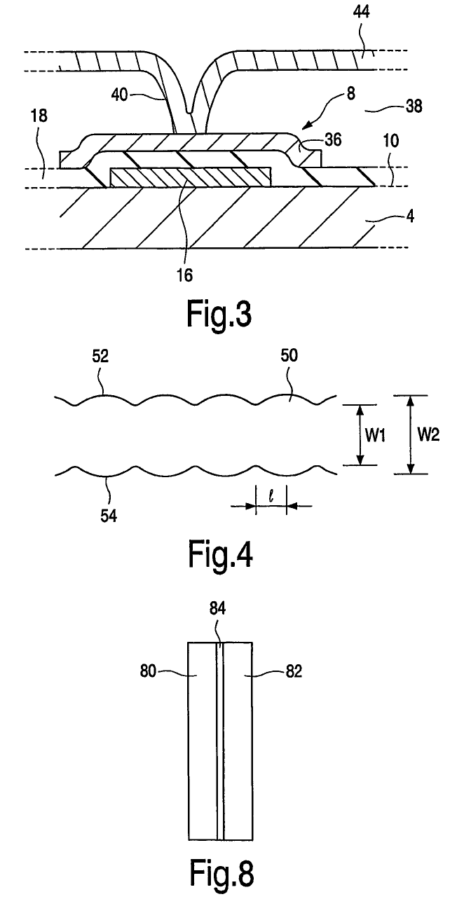

FIG. 3 shows a cross-sectional view of the storage capacitor of FIG. 1 along line B-B;

FIG. 4 shows a plan view of an ink jet printed line;

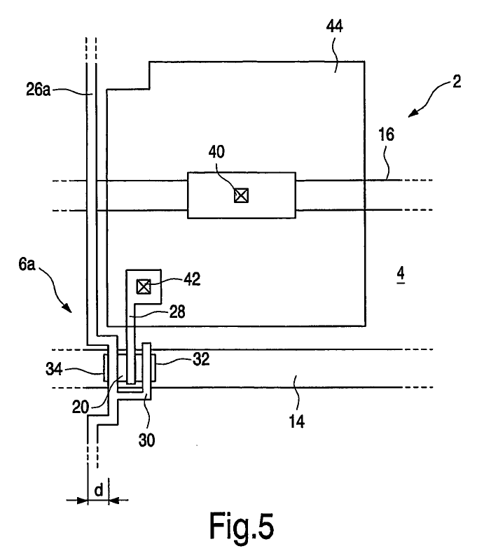

FIG. 5 shows a pixel similar to that of FIG. 1 modified in accordance with a first embodiment of the invention;

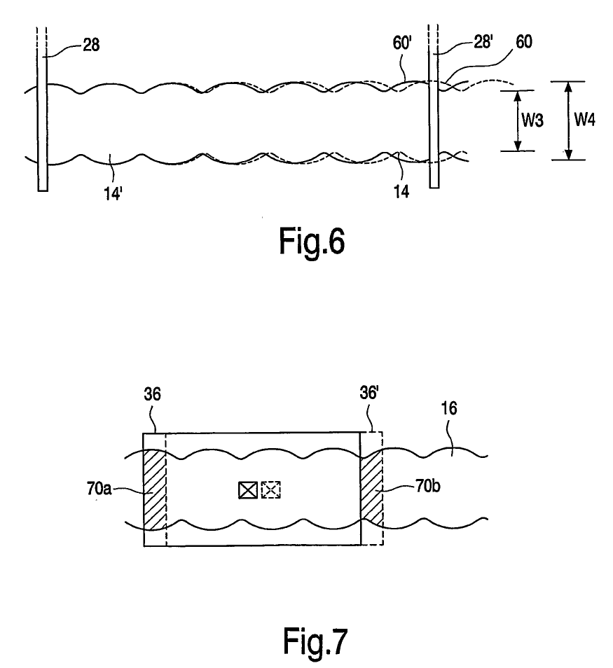

FIG. 6 shows in plan view the variation of the spacing of droplets forming an ink jet printed line in accordance with a second embodiment of the invention;

FIG. 7 shows in plan view the variation of the position of the upper electrode of a storage capacitor; and

FIG. 8 shows a cross-sectional view of a liquid crystal active matrix display according to the invention.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar features in modified and different embodiments.

Unpublished United Kingdom Patent Application No. 0105145.7 of the present applicants (our ref. PHGB010030) describes a TFT structure which is particularly suitable for manufacture using printing techniques. In addition, unpublished United Kingdom Patent Application Nos. 0112563.2 and 0112561.6 of the present applicants (our refs. PHGB010076 and PHGB010077, respectively) disclose pixel storage capacitor configurations adapted for use on display substrates where printing is employed. The contents of these three applications are hereby incorporated herein as reference material.

FIG. 1 illustrates examples of the TFT and storage capacitor structures shown in the unpublished applications referred to above. A single pixel 2 of an array of pixels on a display substrate 4 is shown in FIG. 1. The array of pixels together with the substrate form an active plate of an active matrix display.

The pixel 2 includes a TFT 6. A cross-section through TFT 6 along line A-A perpendicular to the plane of substrate 4 is shown in FIG. 2. Similarly, a perpendicular cross-section through a storage capacitor 8 along line B-B is shown in FIG. 3.

The substrate 4 is made of a transparent material, such as glass, with a substantially flat upper surface 10. A first metallisation layer is printed on the surface 10 and defines a plurality of row electrodes 14 that extend across the substrate 4, and a plurality of storage capacitor electrode lines 16 that also extend across the substrate 4, parallel to the row electrodes 14. A dielectric layer 18, of silicon nitride for example, is provided over the row electrodes 14 and storage capacitor lines 16.

A semiconductor island 20 of the TFT 6 consists of a layer of hydrogenated intrinsic amorphous silicon 22 (i a-Si:H) under a layer of doped hydrogenated amorphous silicon 24 (n+a-Si:H). Typically, these two layers may be deposited one after the other, and then both defined using a single printed mask. The semiconductor island 20 is arranged over the row electrode 14 and are rectangular in plan view, with its long sides parallel to the row electrode 14. The region of the row electrode under the semiconductor island forms the gate electrode of the TFT 6.

A second patterned metallisation layer is defined using photolithography to form a column electrode 26, which extends across the substrate 4 in a direction perpendicular to the row electrode 14. It also forms a drain electrode 28, and a finger 30 which extends from the column electrode 26, around the drain electrode, and back across the semiconductor island 20. The drain electrode 28, finger 30 and column electrode 26 in the region of the semiconductor island 20 extend across the island perpendicularly to the row electrode 14. The column electrode 26 and finger 30 form interconnected source electrodes, either side of drain electrode 28.

As a result of using a printing process such as offset printing to form the semiconductor island 20, the location of its trailing edge 32 may not be accurately controllable or defined. In the absence of the finger 30, the gate-drain capacitance of the TFT would not therefore be well defined. This would lead to non-uniform performance of the TFTs across the active plate of the display. The finger 30 connects to the column electrode 26 the portion of the semiconductor island extending beyond it to the trailing edge 32 of the island to address this problem. It will be appreciated that the finger fulfils the same function if the semiconductor island is printed in the opposite direction, although the location of the leading edge 34 of the island (adjacent to the finger in that case) may be better defined.

In some circumstances, the provision of source electrodes either side of the drain electrode in this way may afford additional benefits. For example, it effectively doubles the channel width, thus lowering the on resistance of the device.

The second metallisation layer is used as an etch mask to carry out a back-channel etching step to etch away the doped amorphous silicon layer 24 where it is exposed. The intrinsic amorphous silicon layer 22 forms the channel of TFT 6.

The second metallisation layer is also used to form the upper electrode 36 of the storage capacitor 8, the dielectric layer 18 acting as the capacitor dielectric between the upper electrode 36 and the storage capacitor line 16. A pixel electrode 44 of indium tin oxide (ITO) is provided over the passivation layer (preferably using a printing process).

A passivation layer 38 is formed over the whole of the substrate. Vias 40 and 42 are provided through the passivation layer 38 above the upper electrode 36 of the capacitor 8 and the drain electrode 28 of the TFT 6, respectively. The passivation layer 38 may be formed of silicon nitride, for example. Other materials may be used, such as polymer material.

The arrangement of layers described above in relation to FIGS. 1 to 3, and especially the simple form of the semiconductor island 20 and the row electrode 14, means that inaccuracies in the definition of the semiconductor island and row electrodes are less critical than with conventional array structures, and so a lower definition process such as printing may be used. The channel length of the TFT 6, being a more important dimension, is instead defined by a higher definition patterning method (ie. photolithography). Indeed, using the TFT structure described above, this may be the only higher definition method needed to fabricate an active plate of an active matrix display.

FIG. 4 illustrates the variation in line width of an ink jet printed electrode, as the width approaches the minimum achievable with a given printing apparatus. The outline of the individual droplets making up the line is apparent, causing an undulation in the edges 52,54 of the line. The width of the line oscillates between a minimum, w1, and a maximum, w2, over a distance, I, equal to half the pitch of the droplets.

It can be seen that the TFT configuration shown in FIGS. 1 and 2 is tolerant of variation in the position of the source/drain metallisation layer with respect to the other layers of the TFT, relative to conventional TFT structures. However, variation in the line width of the row electrode 14 will affect the parasitic coupling capacitance between the drain electrode 28 and the row electrode and therefore the performance characteristics of the TFT.

FIG. 5 shows a pixel 2 similar to that of FIG. 1 which has been modified in accordance with an embodiment of the invention. It differs from that of FIG. 1 in that the TFT 6a has been shifted by a distance, d, in a direction parallel to the row electrode 14, away from the column electrode 26a towards the centre line of the associated pixel electrode 44. Thus, the drain electrode of the TFT overlaps with the row electrode 14 at a different location than would have been the case with the source/drain metallisation pattern shown in FIG. 1. It will be appreciated that the source/drain pattern may be modified in a similar manner to displace the drain electrode over a range of distances to either side of the column electrode 26a. By varying this displacement from pixel to pixel across the display in a substantially irregular manner, the areas of overlap between the drain electrodes of the respective pixels and the droplets forming the row electrode are varied in the same manner.

An alternative embodiment to that illustrated in FIG. 5 is illustrated by FIG. 6. Rather than displace the TFT of each pixel in an irregular manner to achieve the desired non-periodicity in the relative positions of the pixel electrodes and the droplets of the row electrodes, the same result may be achieved by varying the positions of the individual droplets. The droplets are positioned such that the width of the droplet(s) of the row electrode 14 at the locations overlapped by the pixel electrodes 28 varies in a substantially irregular manner across the display.

In FIG. 6, the pixel electrodes 28, 28′ of adjacent pixels are shown, together with a row electrode 14 (in dotted outline) formed of equally spaced droplets, and a second row electrode 14′ having variable droplet spacings. Other features of the respective pixels have been omitted for clarity. It can be seen that the outline of droplet 60′ of electrode 14′ is displaced to the left of its counterpart 60 in electrode 14. The average width, w3, of electrode 14′ at the location of pixel electrode 28′ is smaller than the corresponding dimension of electrode 14, w4. The displacement of the droplet(s) underlying a given pixel electrode may be accommodated gradually by the adjusting the position of the droplets intervening between that pixel electrode and the next. As shown in FIG. 6, the spacing of the droplets in row electrode 14′ between pixel electrodes 28 and 28′ is reduced slightly relative to those of row electrode 14 to accommodate the displacement of droplet 60′ relative to droplet 60.

A further embodiment of the invention is illustrated by FIG. 7. It shows a storage capacitor line 16 and a first upper capacitor electrode 36. A second upper electrode 36′ is also shown (in dotted outline) which is the same size as the first, but displaced therefrom in a direction parallel to the line 16. The area of overlap between the first upper electrode 36 and the line 16 is greater than that between the second upper electrode and the line. Owing to the undulating profile of the ink jet printed line 16, the area 70a covered by the first but not by the second is greater than the area 70b covered by the second but not by the first, resulting in a net reduction in the capacitance of a capacitor including the second upper electrode 36′ relative to a capacitor including the first upper electrode 36. To avoid display artefacts arising from periodic variation in the capacitance of the storage capacitors across a display, the relative positions of the respective upper electrodes and the associated droplets forming the corresponding storage capacitor line may be varied in a substantially irregular manner across the display. In an analogous approach to that of the TFT structures discussed above, this may be achieved either by having regularly spaced droplets and randomly varying the upper electrode position within each pixel, or by randomly varying the location of the droplets associated with the upper electrode in each pixel. As above, any shift in the droplet positions may be gradually accommodated by the droplets between upper electrodes along the same storage capacitor line.

It will be appreciated that, instead of providing a dedicated storage capacitor line 16, a storage capacitor for each pixel may instead be formed using an additional electrode provided over the next or previous printed row electrode 14. Similar considerations as discussed above will apply regarding location of the additional electrode relative to the printed electrode to counteract display artefacts.

A liquid crystal active matrix display may be formed using an active plate 80 made in accordance with the invention as described above by providing a passive plate 82 and sandwiching liquid crystal material 84 between the active and passive plates, in a manner known to those skilled in the art and as illustrated in FIG. 8.

It will be apparent to the skilled reader that the invention is applicable to various printing techniques (including direct writing techniques), of which ink jet printing is one example, wherein areas of material are deposited on a substrate in a desired pattern, and limitations to the resolution of the process may lead to oscillation in the width of printed lines.

Although the invention has been described above in relation to a bottom-gated TFT, it will be appreciated by a person skilled in the relevant art that the invention is equally applicable to pixels comprising top-gated TFTs. In a top-gated TFT, the printed row electrode defining its gate may be deposited after the source/drain metallisation layer, the semiconductor layers and the gate insulating layer have been deposited.

Furthermore, the invention may be applied to a variety of semiconductor technologies. The amorphous silicon layers referred to above may be replaced by other semiconductor types. Examples include polysilicon, microcrystalline silicon, organic semiconductors, II-VI semiconductors such as CdTe, III-V semiconductors such as GaAs, and others. Also, the metallisation layer may be of aluminium, copper or any suitable convenient conductor, not necessarily metal.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

1. A matrix display device comprising an array of pixels, each pixel having a first electrode of oscillating width overlapping with a second electrode, wherein the area of overlap in each pixel between the second electrode and the first electrode is varied across the array in a substantially irregular manner to counteract display artefacts.

2. A device of claim 1 wherein the first electrode is defined using a printing process.

3. A device of claim 2 wherein the first electrode is formed of a line of adjoining droplets.

4. A device of claim 3 wherein the droplets are substantially equally spaced along each line and the position of the second electrodes relative to the droplets in each pixel is varied in a substantially irregular manner across the array.

5. A device of claim 3 wherein the second electrodes in respective pixels are substantially equally spaced along each line of droplets and the positions of the droplets relative thereto in each pixel are varied in a substantially irregular manner along each line.

6. A device of claim 5 wherein the spacing of the droplets along each line between the components is adjusted substantially evenly along the respective line to achieve said variation.

7. A device of Claim 1 wherein an electronic component in each pixel includes the overlapping portions of the first and second electrodes.

8. A device of claim 7 wherein the components are storage capacitors.

9. A device of claim 7 wherein the components are TFTs.

10. A device of claim 9 wherein each pixel includes a pixel electrodes, the second electrode of each pixel is connected to a respective pixel electrode, and the first electrode forms the gate electrode of the TFT.

11. A device of any of claims 7 to 10 wherein each pixel includes a further electronic component having a third electrode formed of a line of adjoining droplets overlapping with a fourth electrode, wherein the area of overlap in each pixel between the third and fourth electrodes of the further component is varied across the array in a substantially irregular manner to counteract display artefacts.

12. A device of claim 9 when dependent on claim 9 or claim 10 wherein the further components are storage capacitors.

13. A device of Claim 1 wherein the row electrodes of the display are formed by the first electrodes.

14. A method of manufacturing a matrix display device comprising an array of pixels, each pixel having a first electrode of oscillating width overlapping with a second electrode, the method comprising the steps of printing the first electrode in each pixel, and defining the second electrode in each pixel, wherein the area of overlap in each pixel between the second electrode and the first electrode is varied across the array in a substantially irregular manner to counteract display artefacts.

15. A method of claim 14 wherein the first electrode is formed in each pixel by ink jet printing a line of adjoining droplets.
